(19) United States
(12) Patent Application Publication
(10) Pub. No.: US 2008/0276760 A1
(43) Pub. Date: Nov. 13, 2008

(54) Driver

(76) Inventor: Jong Phil Kim, Gyeonggi-do (KR)

Correspondence Address: RABIN & Berdo, PC, 1101 14TH STREET, NW, SUITE 500, WASHINGTON, DC, 20005, US

(21) Appl. No.: 12/063,386

(22) PCT Filed: Jul. 27, 2006
(86) PCT No.: PCT/KR2006/002955

§ 371 Date: Feb. 8, 2008

(30) Foreign Application Priority Data
Aug. 11, 2005 (KR) 10-2005-0073947

(51) Int. Cl. B25B 17/00; B25B 23/16

(52) U.S. Cl. 81/57; 81/177.1

(57) ABSTRACT

Provided is a screwdriver. The screwdriver includes: a driver bit; a first main gear axially coupled to the driver bit; first side gears meshed with the first main gear; a second main gear disposed on a same shaft of the first main gear; second side gears meshed with the second main gear and one end of the first side gear; a coupling shaft having one end axially coupled to the second main gear; a front body for applying a rotary power to the second main gear; a rear body connected to the other end of the coupling shaft and rotatably coupled to one end of the front body for transferring power in a driver bit shaft direction; and a clutch interposed between the second main gear and the rear body for blocking a rotary power to be transferred from the front body to the second main gear.

### TECHNICAL FIELD

The present invention relates to a screwdriver; and more particularly, to a screwdriver for inserting and tightening, or lessening and removing screws to/from a target objects through rotating screws.

### BACKGROUND ART

Generally, a screwdriver is a device specifically designed to insert and tighten, or to loosen and remove screws to/from a target object by applying torque through rotating the tip of the screwdriver. The screwdriver is generally classified into a slotted-tip screwdriver and a cross-tip screwdriver.

FIG. 1 shows a conventional screwdriver. As shown in FIG. 1, the conventional screwdriver 30 has a typical structure that includes a driver bit 10 having one end inserted into a groove formed on the head of a slotted screw or a Philip screw and axially rotating itself, and a handle 20 fixed at the other end of the driver bit 10 for allowing a user to provide a rotary torque in order to tighten or loosen a screw to/from the target object.

The conventional screwdriver 30 tightens a screw corresponding to the speed of rotating the screwdriver by a user. That is, the rotating speed of the driver bit 10 is identical to the rotating speed of a screw connected to the driver bit 10. Therefore, the operation efficiency may be degraded when it requires a lot of screws to be tightened in a short time through increasing the rotating speed of the driver bit 10.

### DISCLOSURE OF INVENTION

### Technical Problem

It is, therefore, an object of the present invention to provide a screwdriver having an enhanced structure to improve operating efficiency by selectively controlling the rotating speed of a driver bit connected to a screw.

### Technical Solution

In accordance with one aspect of the present invention, there is a screwdriver including: a driver bit for rotating a screw; a first main gear axially coupled to one end of the driver bit; at least one of first side gears meshed with an outer circumference of the first main gear; a second main gear disposed on a same shaft of the first main gear with a predetermined distance separated; at least one of second side gears meshed with an outer circumference of the second main gear and meshed with an outer circumference of one end of the first side gear at the same time; a coupling shaft having one end axially coupled to the second main gear; a front body housing the first and second main gears, the first and second side gears, and the coupling shaft for applying a rotary power to the second main gear by rotating itself in response to control of a user; a rear body connected to the other end of the coupling shaft, and rotatably coupled to one end of the front body for transferring power in a shaft direction of a driver bit; and a clutch interposed between the second main gear and the rear body for blocking a rotary power to be transferred from the front body to the second main gear if the power is transferred in the shaft direction of the driver bit from the rear body.

A gear groove may be formed at the front body to receive predetermine portions of outer circumference of the first and second side gears.

The front body may be formed to be tapered in the driver bit direction to provide an enhanced grip to a user.

A plurality of grip holes may be formed on the outer surface of the front body to prevent the screwdriver from being slipped.

### Advantageous Effects

A screwdriver according to the present invention rotates a driver bit faster than a front body by including first and second main gears and first and second side gears with different gear ratios. Also, the screwdriver according to the present invention allows a user to quickly and easily tighten screws so as to improve the operating efficiency by selectively transferring or blocking the rotary power of the front body to a first main gear through a clutch after separating the front body and a rear body.

### BRIEF DESCRIPTION OF THE DRAWINGS

The above and other objects and features of the present invention will become apparent from the following description of the preferred embodiments given in conjunction with the accompanying drawings, in which:

FIG. 1 is a perspective view of a conventional screwdriver;

FIG. 2 is a partial cross-sectional view of a screwdriver according to an embodiment of the present invention;

FIG. 3 is a cross-sectional view of FIG. 2 taken along a line III III;

FIG. 4 is a cross-sectional view of FIG. 3 taken along a line IV-IV; and

FIGS. 5 to 7 are views illustrating examples of using a screwdriver of FIG. 2.

### BEST MODE FOR CARRYING OUT THE INVENTION

Other objects and aspects of the invention will become apparent from the following description of the embodiments with reference to the accompanying drawings, which is set forth hereinafter.

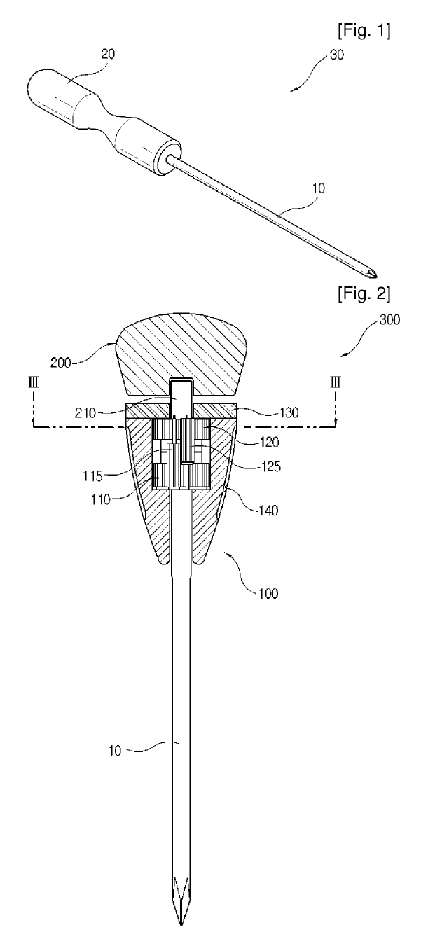

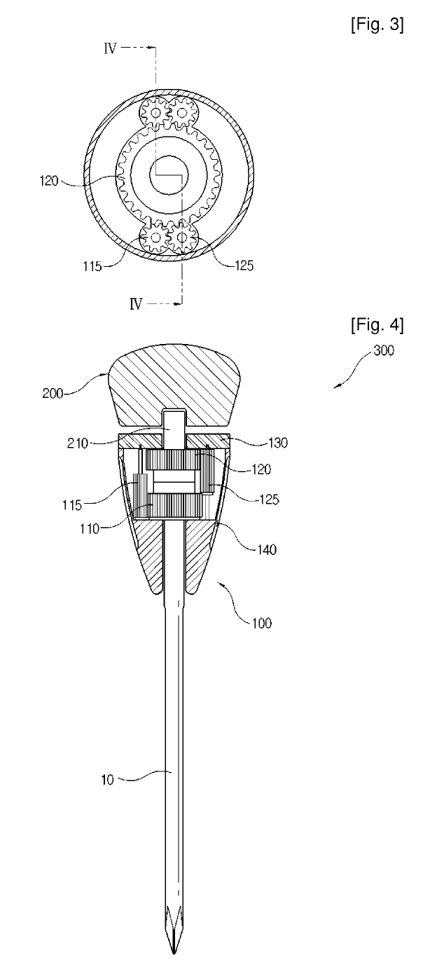

FIG. 2 is a partial cross-sectional view of a screwdriver according to an embodiment of the present invention, FIG. 3 is a cross-sectional view of FIG. 2 taken along a line III III, and FIG. 4 is a cross-sectional view of FIG. 3 taken along a line IV-IV.

Referring to FIG. 2, the screwdriver 300 according to the present embodiment includes a driver bit 10 having one end inserted into a groove formed on a head of a screw for rotating the screw, a front body 100 connected to the other end of the driver bit 10 for applying a rotary power to the driver bit 10 in response to the control of a user, and a rear body 200 connected to the front body 100 with a predetermined distance separated.

As shown in FIGS. 2 to 4, the screwdriver 300 according to the present embodiment includes a first main gear 110 axially connected to the one end of the driver bit 10, at least one of first side gears 115 meshed with the outer circumference of the first main gear 110, a second main gear 120 disposed on the same shaft of the first gear 110 with a predetermined distance separated, at least one of second side gears 125 meshed with the outer circumference of the second main gear 120 and the outer circumference of the one end of the first main gear 115 at the same time, and a coupling shaft 130 having one end axially coupled to the second main gear 120. The front body 100 houses the first and second main gears 110 and 120, the first and second side gears 115 and 125, and the coupling shaft 130. Furthermore, the first and second main gears 110, 120 and the first and second side gears 115 and 125 are disposed to have different gear ratios. For example, it is preferable that the first and second main gear 110 and 120 and the first and second side gears 115 and 125 may have 2:1 as a gear ratio.

Moreover, the screwdriver 300 according to the present embodiment includes a clutch 130 disposed between the front body 100 and the rear body 200. Such a clutch 130 is disposed between the second main gear 120 housed in the front body 100 and the rear body 200, and the clutch 130 selectively transfers or block the rotary power provided from the front body 110 according to the rotation made by a user to the second main gear 120.

Meanwhile, a rear body 200 is connected to the other end of the coupling shaft 210, and rotatably coupled to one end of the front body 110. Such rear body 200 transfers power in a shaft direction of a driver bit 10 when pressed by the user. The rear body 200 transfers power in a shaft direction of a driver bit 10 to operates the clutch 130 when pressed by the user.

The screwdriver 300 according to the present embodiment allows a user to selectively control the rotating speed of the screwdriver 300 by including the clutch 130 and the rear body 200.

The front body 100 includes gear grooves 116 and 126 formed inside thereof for receiving a predetermined portion of an outer circumference of the first and second side gears 115 and 125 for applying the rotary power in response to operations made by a user. Also, the front body 100 is tapered toward the driver bit 100 to form an enhanced grip for a user. Furthermore, a plurality of grip grooves 140 may be formed on the outer side of the front body 100 in order to prevent the user's hand from being slipped. Therefore, the operation efficiency of the screwdriver 300 according to the present embodiment is improved because the screwdriver 300 allows a user to conveniently and firmly hold the screwdriver 300 by preventing the user's hands from being slipped.

Hereinafter, the operation of the screwdriver 300 according to the present embodiment will be described. At first, if a user rotates the screwdriver 300 with the front and rear bodies 100 and 200 held as it is, the second side gear 125 moves around the second main gear 120 while the second side gear 125 disposed at the gear groove 126 of the front body 100 rotates on its axis. Also, the rotating of the second side gear 125 makes the first side gear 115 mashed with the second side gear 125 to rotate on its own axis. Then, the first side gear 115 moves around the first main gear 110 while rotating its own axis. The moving of the first side gear 115 makes the first main gear 110 to axially rotate. Herein, the first main gear 110 rotates with a faster rotating speed than the first side gear 115 because the first side gear 115 and the first main gear 110 have a different gear ratio. For example, it assumes that the gear ratio between the first main gear 110 and the first side gear 115 is 2:1. When the second side gear 125 rotates by the rotating of the front body 100, the first side gear 115 mashed with the second side gear 125 moves around the first main gear 110 at one lap. Since the first main gear 110 is mashed with the first side gear 115, the first main gear 110 axially rotates at two laps while the first side gear 115 moves around the first main gear 110 at one lap. Accordingly, the first main gear 110 can make the driver bit 10 to rotate at a faster rotating speed than its rotating speed. Therefore, the operating efficiency of the screwdriver according to the present embodiment is improved because the driver bit 10 rotates at a faster rotating speed although a user rotates the front body 100 at a slower rotating speed.

Meanwhile, the rotary power of the driver bit 10 can be enhanced by rotating the screwdriver 300 with the rear body 200 adhered closely to the front body 100. It will be described in more detail hereinafter.

When a user rotates the screwdriver 300 after adhering the rear body 200 closely to the front body 100, the rear body 200 transfers the power in the shaft direction of the driver bit 10. Accordingly, the clutch 130 interposed between the second main gear 120 and the rear body 200 adheres closely to the second main gear 120 to block the rotary power transferred from the front body 100 to the second main gear 120. Such an operation of the clutch 130 makes the driver bit 10 to rotate with more power while rotating at the same rotating speed of the front body 100 and the rear body 200.

Also, the screwdriver 300 according to the present embodiment may increase the rotary power of the driver bit 10 without driving the clutch 130 by adhering the rear body 200 closely to the front body 100. That is, if a user rotates the front body 100 and the read body 200 as one piece with the front body 100 and the rear body 200 held as it is, the rotary power is not transferred to the gears disposed inside the front body 100. Since the rotary power is not transferred to the driver bit 10 through the gears, the driver bit 10 rotates at the same rotating speed of the front body 100 and the rear body 200. As a result, the driver bit 10 rotates with more rotary power.

In addition, the driver bit 10 of the screwdriver 300 according to the present embodiment may be provided to be detachable/attachable from/to the front body 100. In this case, other member for transferring a rotary torque, such as a hexagon wrench, may be used as well as the driver bit 10.

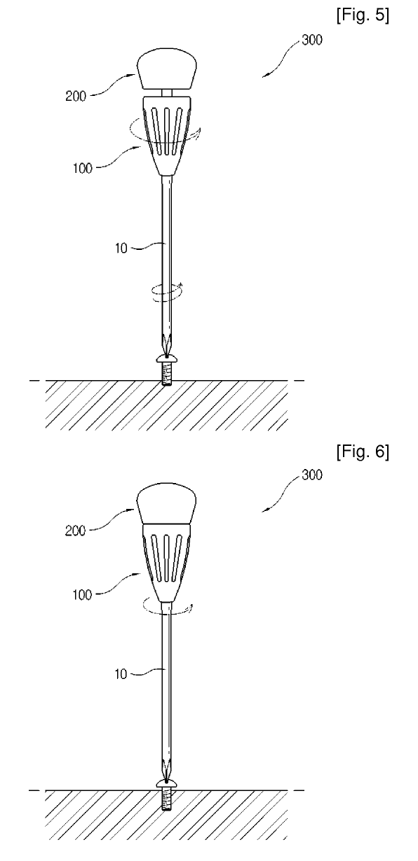

FIG. 5 is a view showing an example of using the screwdriver of FIG. 2.

Referring to FIG. 5, when a user is required to tighten a screw with less rotary power, a user rotates only the front body 100 without adhering the front body 100 closely to the rear body 200. As a result, the driver bit 10 rotates at a faster rotating speed than that of the front body 100. For example, the driver bit 10 rotates two times faster than that of the front body 100. It is possible to rotate the driver bit 10 faster than two times of the rotating speed of the front body 100 through controlling the gear ratio if it is necessary. Therefore, the user can quickly tighten the screws in a short time because the screws rotate at the faster rotating speed although the front body 100 rotates at the slower rotating speed.

FIG. 6 is a view showing an example of using a screwdriver after a screw is tightened at a predetermined level.

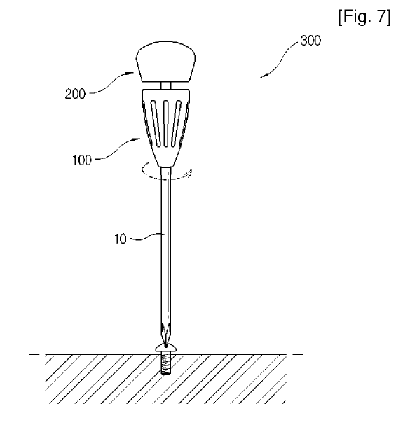

Referring to FIG. 6, a user is required to apply more rotary power to a screw in order to overcome the friction force after the screw is tightened to a target object at a predetermined level. In order to apply more rotary power, a user rotates the screwdriver 300 after holding the rear body 200 closely to the front body 100 as shown in FIG. 6. More rotary power may be provided to a screw by rotating front body 100 and the rear body 200 as one piece with the front body 100 and the rear body 200 held as it is without closely adhering the rear body 200 to the front body 100, as shown in FIG. 7.

While the present invention has been described with respect to certain preferred embodiments, it will be apparent to those skilled in the art that various changes and modifications may be made without departing from the scope of the invention as defined in the following claims.

1. A screwdriver comprising:
a driver bit for rotating a screw;
a first main gear axially coupled to one end of the driver bit;
at least one of first side gears meshed with an outer circumference of the first main gear;
a second main gear disposed on a same shaft of the first main gear with a predetermined distance separated;
at least one of second side gears meshed with an outer circumference of the second main gear and meshed with an outer circumference of one end of the first side gear at the same time;
a coupling shaft having one end axially coupled to the second main gear;
a front body housing the first and second main gears, the first and second side gears, and the coupling shaft for applying a rotary power to the second main gear by rotating itself in response to control of a user;
a rear body connected to the other end of the coupling shaft, and rotatably coupled to one end of the front body for transferring power in a shaft direction of a driver bit; and
a clutch interposed between the second main gear and the rear body for blocking a rotary power to be transferred from the front body to the second main gear if the power is transferred in the shaft direction of the driver bit from the rear body.

2. The screwdriver of claim 1, wherein a gear groove is formed at the front body to receive predetermine portions of outer circumference of the first and second side gears.

3. The screwdriver of claim 2, wherein the front body is formed to be tapered in the driver bit direction to provide an enhanced grip to a user.

4. The screwdriver of claim 2, wherein a plurality of grip holes are formed on the outer surface of the front body to prevent the screwdriver from being slipped.

5. The screwdriver of claim 1, wherein the front body is formed to be tapered in the driver bit direction to provide an enhanced grip to a user.

6. The screwdriver of claim 1, wherein a plurality of grip holes are formed on the outer surface of the front body to prevent the screwdriver from being slipped.
